(19) United States
(12) Patent Application Publication
(10) Pub. No.: US 2011/0067417 A1
(43) Pub. Date: Mar. 24, 2011

(54) METHOD AND APPARATUS FOR COOLING LIQUIDS

(76) Inventor: Giuseppe Leonardo Quarini, Oxon (GB)

(21) Appl. No.: 10/579,110

(22) PCT Filed: Nov. 11, 2004
(86) PCT No.: PCT/GB2004/004755

§ 371 Date: May 14, 2007

(30) Foreign Application Priority Data
Nov. 13, 2003 (GB) 0326491.8

(51) Int. Cl. F17C 7/02; F25D 13/00

(52) U.S. Cl. 62/52.1; 62/63

(57) ABSTRACT

A feed liquid, for example, a molten fat, is formed into at least one sheet of flowing particles and is cooled by directing cryogen at the particles from both sides of the sheet. By this means, a molten liquid such as fat may be spray crystallised.

This invention relates to a method and apparatus for cooling liquids.

It is frequently desired in industry to cool liquids rapidly. One example of such a requirement is when the liquid is to be converted into solid particles and rapid cooling promotes favourable microstructural features, or the absence of unfavourable microstructural features, in the resulting solidified particles.

It is known to carry out the rapid cooling by atomising the feed liquid and contacting the resulting atomised feed liquid with a cryogen such as liquid nitrogen. The necessary heat can be extracted from the atomised particles in only a fraction of the time that would be needed were the necessary cooling to be performed on an undivided body of the feed liquid. Further, if the feed liquid is supplied at or above ambient temperature, the large temperature difference between the atomised particles and the liquid feed facilitates rapid cooling. If the cryogen is a liquefied gas, its enthalpy of evaporation can also be contributed to the cooling.

EP-B-0 393 963 relates to the cryogenic crystallisation of molten fats. The molten fat is sprayed from an atomising nozzle facing vertically downwards. A divergent flow of atomised particles in the shape of a vertical cone is formed. The cone is arranged to be coaxial with a liquid nitrogen spraying which directs jets of droplets of liquid nitrogen radially inwards at the conical flow of the atomised particles of the molten fat. The jets are directed downwards at an angle of 45° so as to prevent impingement of the liquid nitrogen on the atomising nozzle itself. As a result of contact between the atomised particles of molten fat and the droplets of liquid nitrogen, the fat is almost instantaneously converted into solid particles having a favourable microcrystalline structure.

In commercial practice, the apparatus according to EP-B-0 393 963 is located at the top of a cylindrical chamber. The solid particles of the fat are extracted at the bottom of the chamber. We have found that recirculation patterns are created in the chamber which prevent effective operation of the apparatus at its maximum theoretical capacity. Accordingly, to meet a large demand for the crystallisation of fat several such chambers would be required.

The above-described problem is not confined to the cryogenic spray crystallisation of fats and oils. It applies in the cryogenic cooling of particles of any liquid.

According to the present invention there is provided a method of cooling a feed liquid comprising forming at least one sheet of flowing particles of the feed liquid and directing cryogen at the particles from both sides of the sheet.

The invention also provides apparatus for cooling a feed liquid, comprising at least one nozzle for forming at least one sheet of flowing particles of the feed liquid, at least one first cryogen discharge member having a plurality of cryogen discharge orifices arranged for directing cryogen at one side of the sheet, and at least one second cryogen discharge member having a plurality of cryogen discharge orifices arranged for directing cryogen at the other side of the sheet.

By arranging the flow of the particles of the liquid in a relatively flat space, i.e. a sheet, rather than in a cone, as in EP-B-0 393 963, it becomes possible to limit recirculation of the particles of the feed liquid. As a result, it becomes possible to operate the atomising nozzle at nearer its maximum theoretical flow rate than in the prior arrangement discussed above. Further, more efficient utilisation of the cryogen is made possible by the method and apparatus according to the invention. Another advantage of the method and apparatus according to the invention is that by arranging the nozzles in lines relatively large throughputs of liquid can be achieved in a single chamber of similar size to that which would be required were a single nozzle to be used. In addition, for even larger throughputs of feed liquid, a plurality of contiguous cuboidal or box-shaped chambers can be employed without adding greatly to the space occupied by the apparatus according to the invention.

The sheet of flowing particles of the feed liquid is typically formed by atomising the feed liquid. The feed liquid is preferably atomised by a compressed gas and the nozzle may therefore have an inlet for the atomising gas. Alternatively, mechanical atomisation may be employed.

The or each atomising nozzle preferably points vertically downwards so as typically to provide a flow of particles of the liquid in a vertical plane.

The or each sheet of particles of the liquid particles may be essentially planar. Such a sheet may be produced by a nozzle having a rectilinear elongate outlet. Alternatively, the nozzle may have a row of separate outlets which cooperate together to provide a flow of liquid particles in the form of a sheet. If a plurality of nozzles is employed, the nozzles may be arranged in one or more straight lines. Preferably some or all of the straight lines are parallel to one another. One or more parallel rows of nozzles may therefore be provided. The sheets formed by adjacent nozzles may be contiguous to one another, may merge into one another or may be spaced apart. In alternative arrangements the nozzles may be disposed in straight lines that define a geometric figure, for example, a triangle, a square or a polygon. An advantage of providing the nozzles in parallel rows or along the sides of a geometric figure is that several nozzles can readily be accommodated in a single chamber.

In an alternative geometric arrangement a curved sheet of particles of the feed liquid is produced. A nozzle having a curved or arcuate elongate outlet may be employed to provide such a curved sheet of particles. If desired, a plurality of such nozzles may be arranged circumferentially with the result that the sheets can define together a generally hollow cylindrical shape. Such an arrangement is another that offers the advantage of enabling several nozzles to be readily accommodated in a single chamber.

The orifices of the first and second cryogen discharge members are preferably disposed in geometric configurations complementary to that or those of the nozzle. For example, if there is a single line of nozzles, then that line is flanked on one side by a complementary line of cryogen discharge orifices in the first cryogen discharge member and on its other side by a complementary line of cryogen discharge orifices in the second cryogen discharge member. Alternatively, if the nozzles are arranged circumferentially, there is a complementary inner and a complementary outer ring of cryogen discharge orifices.

The orifices of the first and second discharge members are preferably disposed such that in use they are all equidistant from the sheet of particles at which they are directed. They are also all preferably orientated so as to direct cryogen at the sheet of particles near to its source.

In one preferred arrangement of the apparatus according to the invention the nozzles are disposed in the upper region of a single, generally cuboidal, chamber. In another arrangement the nozzles are disposed in the upper regions of a plurality of contiguous generally cuboidal chambers. Such an arrangement lends itself to a modular construction of the apparatus according to the invention. If, for example, it is determined that an apparatus with a single chamber of given dimensions with a specified number of atomising nozzles can cool a particular feed liquid at a certain feed liquid flow rate, then if, say, it is desired to cool the same liquid at four times the liquid flow rate, four identical chambers will be required. Preferably, if an arrangement of contiguous chambers is required the chambers are open to one another through their common sides.

Typically, the first and second cryogen discharge members are both spray headers.

The method according to the invention may be used to cool a large number of different feed liquids. The feed liquid may be a molten substance which is a solid at 15° C. and which needs to be heated to above 15° C. in order to be converted to a liquid. Alternatively, the feed liquid may naturally occur as a liquid at 15° C. For example, it may be an aqueous liquid. The method according to the invention is particularly suitable for solidifying a liquid. Various examples of liquids that may be so solidified include, molten fats, oils, and aqueous solutions, emulsions and dispersions. The resulting solid particles may have use as foodstuff or a pharmaceutical or may be used in the manufacture of other products. Alternatively, the feed liquid to be solidified (in the form of a powder) may be a molten metal or alloy.

The method according to the invention is particularly suited to the solidification and crystallisation of (edible) molten fats, oils, and other edible substances. Rapid cooling typically enables a desirable and stable microcrystalline structure to be obtained within the particles of the fat. By forming atomised particles of an average size of less than 50 μm, more preferably of less than 10 μm, and most preferably of less than 5 μm extremely rapid cooling rates can be achieved, for example a rate of at least 1000 K/s. Accordingly, the liquid can be essentially completely solidified at the exit from the chamber.

The cryogen is preferably a liquefied gas which preferably has a boiling point lower than −100° C., although liquefied carbon dioxide which has a triple point of −78° C. can be used instead, the liquefied carbon dioxide being converted into a mixture of gas and solid particles on passing through the cryogen discharge orifices. The preferred liquefied gas is liquid nitrogen, although liquid argon or liquid air may alternatively be used.

The nozzle(s) and the cryogen discharge members are typically housed in a chamber having an outlet for the chilled particles and the same or a different outlet for spent cryogen. The apparatus according to the invention may advantageously include a sensor for sensing the temperature of the spent cryogen, the sensor being operatively associated with at least one flow control valve for controlling the flow of cryogen to the cryogen discharge members. Such an arrangement enables the flow of cryogen to be adjusted automatically in concert with changes in the flow of the feed liquid so as to ensure that adequate cooling of the particles is obtained, for example, so as to achieve internal as well as external solidification of the particles, without the spent cryogen having an unnecessarily low exit temperature from the chamber. Alternatively, the flow rate of the cryogen may be adjusted manually on the basis of previous experiments determining the optimum cryogen flow rates for different feed liquid flow rates.

In the solidification of liquids there is a tendency of some fine solid particles to be carried out of the chamber entrained in the spent cryogen. The apparatus according to the invention therefore preferably includes a cyclone communicating with the outlet for gas from the chamber so as to disengage the fine particles from the spent cryogen. If desired, once the fine particles have been disengaged, the spent cryogen may be compressed in a compressor and used to atomise the feed liquid. Alternatively, a separate compressed gas such as air can be used to atomise the feed liquid. Using spent cryogen, if that cryogen is, say, nitrogen, is advantageous in the event of air adversely affecting, for example, oxidising, the feed liquid. If there is such recycle of the spent cryogen, the chamber may have another outlet for spent cryogen. The third outlet may communicate with a baghouse for disengaging fine particles from the spent cryogen.

The method and apparatus according to the invention will now be described by way of example with reference to the accompanying drawings, in which:

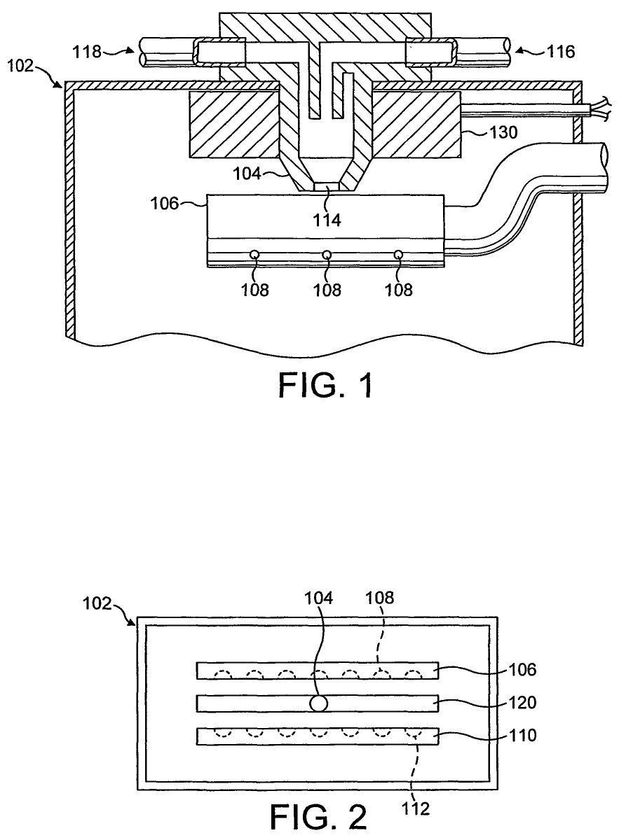

FIG. 1 is a schematic sectional side elevation of a cryogenic spray crystalliser having a single feed nozzle;

FIG. 2 is a schematic plan view of the crystalliser shown in FIG. 1;

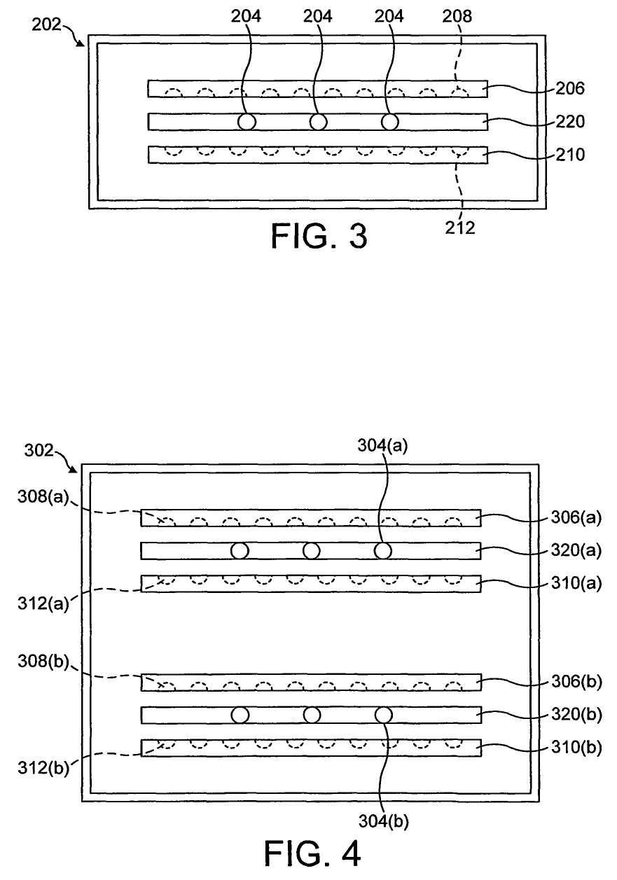

FIG. 3 is a schematic plan view of an alternative crystalliser employing a single line of feed nozzles;

FIG. 4 is a schematic plan view of a further alternative crystalliser employing two parallel lines of feed nozzles;

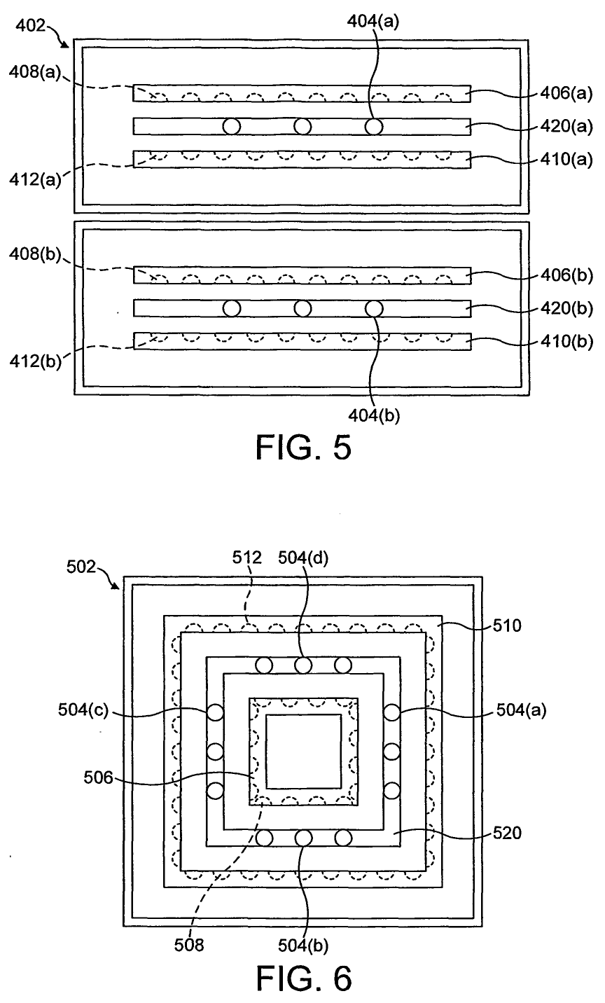

FIG. 5 is a schematic plan view of another alternative crystalliser employing two parallel lines of feed nozzles, one employed in a first chamber and the other in a second chamber;

FIG. 6 is a schematic plan view of yet another alternative crystalliser, employing an arrangement of feed nozzles around the sides of a square;

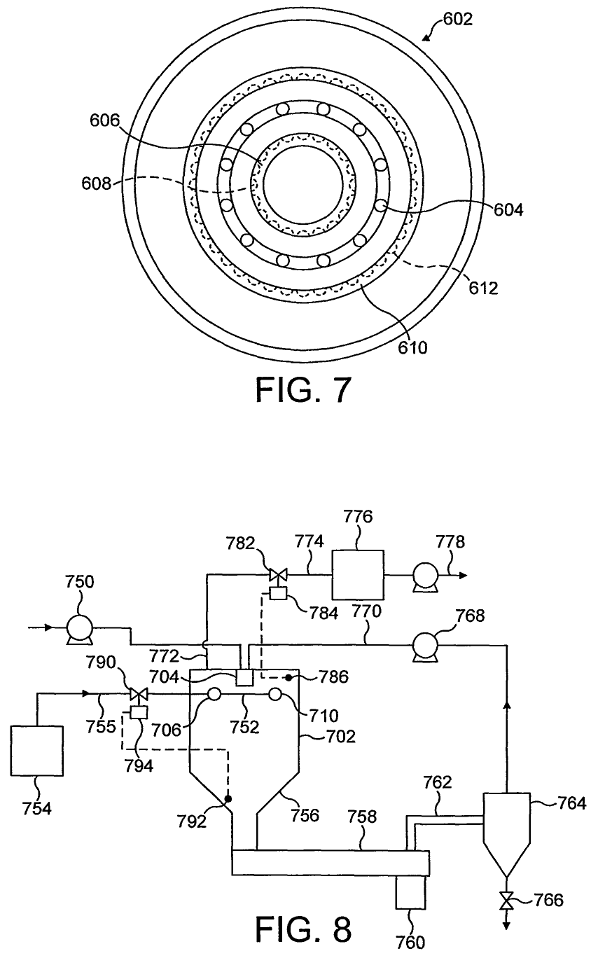

FIG. 7 is a schematic plan view of a final alternative crystalliser, employing a circumferential arrangement of feed nozzles; and

FIG. 8 is a general schematic view of an apparatus which may incorporate any of the forms of crystalliser illustrated in FIGS. 1 to 7.

The drawings are not to scale. In FIGS. 2 to 7, the views are with the top of the crystalliser chamber omitted and with the corrections of the atomising nozzles and the spray headers to, respectively, a molten fat supply line and a liquid nitrogen supply line, not shown.

With reference to FIGS. 1 and 2, a generally box-shaped (cuboidal) chamber 102 houses a single nozzle 104 for atomising molten liquid fat, a first cryogen discharge device in the form of a first spray header or tube 106 having a row of cryogen discharge orifices 108 formed in it and a second cryogen discharge device (not shown in FIG. 1) in the form of a second spray header or tube 110 having a row of cryogen discharge orifices 112 formed in it.

The atomising nozzle 104 is mounted at the top of the chamber 102 and has an elongate, rectilinear outlet 114 facing vertically downwards into the chamber 102. The nozzle 104 has a first inlet 116 for the molten fat communicating with a source (not shown) of the molten fat and a second inlet 118 for atomising gas communicating with a source (not shown) of the atomising gas. The molten fat is typically pumped to the nozzle at elevated pressure, for example in the range of 2 to 10 bar, though, if desired, higher pressures, say, up to 30 bar may be used. A peristaltic pump may be used for this purpose. The atomising gas is typically also provided under a pressure in the range of 2 to 10 bar and the internal configuration of the atomising nozzle 104 is such that the stream of molten fat supplied to it issues as particles in the form of very fine droplets. Such atomising nozzles are known and are commercially available. It is generally desirable that the molten fat (or other liquid to be atomised) be supplied at a higher pressure than the atomising gas.

In view of the shape of the outlet 114, the outer contour of the downwardly directed spray of liquid fat particles issuing from the nozzle 104 is not in the shape of a cone that is entirely symmetrical about the axis of the nozzle 104, but is instead more in the shape of a thin planar sheet 120. Typically, particularly when the nozzle 104 is operated at close to its maximum throughput, the sheet 120 may fan out, particularly vertically, but in horizontal cross-section always has a large aspect ratio. The first spray header 106 is positioned on one side of the sheet 120 with its orifices 108 facing the sheet 120. The orifices 108 in the spray header 106 are typically circular in shape and are of small diameter. The number and size of the orifices 106 may be chosen in accordance with the flow rate of the molten fat out of the atomising nozzle 104. The orifices 108 are evenly spaced. The spray header 106 is positioned such that the cryogen impacts the particles of molten fat at points relatively close to the tip of the nozzle 104, though not so close as to cause any solidification of the molten fat in the nozzle 104 itself. For this reason, the orifices 106 do not point horizontally at the sheet 120, as in this event some cryogen will tend to issue with a component of momentum in the upward direction, but instead are pointed downwards at angle to the horizontal of up to 45°. The extent of the row of orifices 106 is sufficiently wide that the particles will encounter cryogen across the entire width of the sheet in the region of contact between the cryogen and the particles of the molten fat.

The cryogen is preferably liquid nitrogen, although, for example, liquid argon or liquid air could be used instead. All these cryogens have in liquid state a temperature well below −100° C. Accordingly, they are at a substantially lower temperature than the molten fat which is typically provided at a temperature above +50° C. They are accordingly effective coolants. They provide not only cooling by the extraction of sensible heat from the particles of the atomised fat, they also provide cooling by the extraction of heat necessary for the vaporisation of the liquefied gas. In practice, therefore, they are able to provide almost instantaneous solidification of the particles of molten fat particularly if the size of the latter is kept to below 10 microns. Since there is a tendency for some of the liquefied gas to vaporise as it flows from the spray header 106 into contact with the flowing particles within the contours of the sheet 120, it is desirable that this distance of travel is kept to a minimum. Accordingly, the length of the path that the liquefied gas has to travel before encountering the particles of molten fat is preferably less than 50 mm. It is also desirable to cause the liquid nitrogen or other liquefied gas to be ejected from the orifices 108 in the form of droplets at high velocity. This result can be achieved by supplying the liquefied gas to the spray header 106 under an elevated pressure, typically in the range of 2 to 6 bar. The liquefied gas may be stored at a suitably elevated pressure and there is generally no need to use a mechanical pump to create a flow of pressurised liquefied gas. The liquefied gas is preferably conducted to the spray header 106 through a thermally-insulated pipeline (not shown). If the storage vessel (not shown) for the liquefied gas is remote from the spray crystalliser, it may be desirable to disengage vaporised gas from the liquid at a location close to the spray crystalliser. Devices for effecting such disengagement are well known in the art.

The second spray header 110 is essentially a mirror image of the first spray header 106 and therefore has a size, number and spacing of its cryogen discharge orifices 112 equal to those of the spray header 106. The second spray header 110 (as shown in FIG. 2) is located on the opposite side of the sheet 120 of particles from the first spray header 106. The distance between, the row of orifices 112 and the sheet 120 is equal to that between the row of orifices 108 and the sheet 120. Accordingly, there is no net lateral displacement of the particles of molten fat as they are impacted upon by the cryogen. Further, the confining of the particles to flow in a relatively thin sheet 120 facilitates the rapid contacting of them with the cryogen and therefore their rapid, essentially instantaneous solidification.

Although not shown in FIGS. 1 and 2, the chamber 102 is essentially open at its bottom, and the resulting solidified particles of fat may be collected as a free-flowing powder in a stationary or moving collection device. The collection device may, for example, be an auger. Notwithstanding that the known spray crystalliser described in the introductory paragraphs of this specification was similarly open at the bottom, we have found that considerably recirculation of particles of solidified fat tend to take place. In a comparable spray crystalliser according to the invention recirculation is considerably reduced.

Various edible fats and compositions containing fat may be solidified with advantage by the method and the apparatus according to the invention. For example, hydrogenated fats so crystallised are found to have superior rheological properties to those crystallised by conventional scraped heat exchanger surface technology. This is attributed to the formation of a particulate product with a multiplicity of microcrystals in a liquid oil phase within the body of each solidified particle. The almost instantaneous achievement of a maximum number of crystals per unit mass of solid fat in the product has the consequence that in certain food compositions the proportion of hydrogenated fat can be reduced without loss of qualitative properties such as texture, taste and general organoliptic attributes. Present day research into coronary and other diseases suggests that such a reduction would be beneficial to human beings consuming such compositions or foodstuffs prepared from them. Examples of hydrogenated fats that can be solidified and crystallised by the method and apparatus according to the invention include hydrogenated rape seed oil, hydrogenated soya bean oil, hydrogenated palm oil, and hydrogenated sunflower oil.

It is also possible to solidify edible oil-in-water emulsions of dairy or vegetable fats by the method and with the apparatus according to the invention without substantial destabilisation of the emulsion on remelting the resultant solid particles. An example of such an emulsion that can be effectively solidified or frozen in this way is whipping cream.

Referring again to FIG. 1 of the drawings, the nozzle 104 is optionally surrounded by a heating element 130 which is operable to prevent any of the molten fat flowing therethrough from solidifying. The heating element 130 may be operated intermittently or continuously, or only at start up or when cleaning the apparatus shown in FIG. 1. A further electrical heating element (not shown) may be used to heat the walls of the chamber 102 at the end of operation to melt any solidified fat which has accumulated during operation on their inner surfaces.

All the parts of the apparatus shown in FIGS. 1 and 2 may be made from materials whose use is acceptable in the food industry, for example, stainless steel.

Referring now to FIG. 3, there is illustrated an apparatus comprising a generally box-shaped chamber 202 housing a row of nozzles 204 for atomising liquid fat and producing a sheet or sheets 220 of atomised fat particles, a first cryogen discharge device or member in the form of a first spray header or tube 206 having a row of cryogen discharge orifices 208 formed in it and a second cryogen discharge device or member in the form of a second spray header or tube 210 having a row of cryogen discharge orifices 212 formed in it. The apparatus shown in FIG. 3 has a configuration and operation analogous to that shown in FIGS. 1 and 2 save that instead of a single atomising nozzle 104, there is now a straight line row of at least two and typically three or more atomising nozzles 204. These nozzles 204 are spaced so as to elongate the sheet or curtain of particles produced in operation relative to that shown in FIGS. 1 and 2. The individual “sheets” 200 produced by the individual nozzles are preferably contiguous, but could be spaced, or, less preferably merge into one another at a level above, at or below the region upon which the cryogen impinges. In consequence the spray headers 206 and 210 and the rows of orifices 208 and 212 need to be longer than in their counterparts in the apparatus shown in FIGS. 1 and 2. If, for example, the apparatus shown in FIG. 3 has a row of three nozzles 204 it may produce spray crystallised fat particles at up to three times the rate of the apparatus shown in FIGS. 1 and 2 without any comparable increase in the volume of the chamber and without creating the recirculation problems that are associated with operation of the known spray crystalliser which produces a conical distribution of particles.

Although not shown in FIG. 3, the three nozzles may be supplied with pressurised molten fat from a header located outside the chamber 202.

Referring now to FIG. 4 of the drawings, the apparatus illustrated therein comprises a generally box-shaped chamber housing two arrays of nozzles and spray headers, both wholly analogous in configuration and operation to the single arrange described above with reference to FIG. 3. The first arrange comprises a row of nozzles 304(a) for atomising liquid or molten fat and producing a sheet 320(a) of descending particles, a first cryogen discharge member in the form of a first spray header or tube 306(a) having a row of cryogen discharge orifices 308(a) formed in it and a second cryogen discharge device or member in the form of a second spray header or tube 310(a) having a row of cryogen discharge orifices 312(a) formed in it. The second array is analogous and its nozzles 304, spray headers 306 and 310, and orifices 308 and 312 are all shown in FIG. 4 with the suffix (b). If there is a total of six nozzles 304 in the two rows, then the apparatus is operable at up to six times the production rate of that described above without there being recirculation problems but at the expense of a larger chamber. Indeed, if desired, the length of each row may be extended so as to accommodate additional atomising nozzles. It is also possible to place a third row of atomising nozzles 304 between the other two rows and arrange for the spray headers 310(a) and 306(b) to be provided each with a second set of orifices such that they direct cryogen at liquid issuing from the third row of atomising nozzles and effect its spray crystallisation. If desired, further rows of atomising nozzles and the requisite further cryogen spray headers may be accommodated.

The apparatus shown in FIG. 5 of the drawings embodies a different approach to the design of a spray crystalliser capable of operating at a production rate many times in excess of the maximum achievable with the apparatus described above with reference to FIGS. 1 and 2. now there are two identical contiguous chambers 402(a) and 402(b), one array of nozzles 404(a), and spray headers 406(a) and 410(a) with respective rows of orifices 408(a) and 412(a) being housed in the chamber 402(a) and producing a sheet 420(a) of particles and the corresponding parts identified by the suffix (b) being housed in the chamber 402(b). Although the two chambers 402(a) and 402(b) may occupy a larger volume than the single chamber 302 of the corresponding apparatus described above with reference to FIG. 4, because they are of identical configuration, they make possible the execution of a modular approach to the design and construction of a spray crystalliser. Thus it is possible to build and operate a spray crystalliser comprising a row of such modular units. Further, in view of the large aspect ratio of the sheet or contiguous sheets of particles in each chamber, the aspect ratio of each chamber is similarly large. Thus, each time a module is attached, the aspect ratio may be reduced, with the increase in size of the apparatus taking place in one dimension only.

Referring now to FIG. 6, there is shown a yet further apparatus embodying another different design approach. Now there are four rows of atomising nozzles 504(a), 504(b), 504(c) and 504(d), arranged on the sides of a square in an upper region of a box-shaped chamber 502. Each row of atomising nozzles 504 has two spray headers 406 and 510 associated with it, one located on one side of the-four sided figure defined by the “sheets” 520 of atomised molten fat particles, and the other located on the other side. The spray headers 506 and 510 are endless and square in configuration and are formed with rows 508 and 512, respectively, of cryogen discharge orifices. If there are three nozzles 504 in each row, then the apparatus shown in FIG. 6 is capable of operating at a production rate of up to 12 times higher than the apparatus shown in and described with reference to FIGS. 1 and 2. A disadvantage of the apparatus shown in FIG. 6 is, however, that such is the number of spray headers and nozzles in a confined space that there may be difficulties in accommodating all the associated piping without making the chamber 502 unnecessarily large. (In general, it is preferred to minimise the cross-sectional area of the chamber such that it is not that much greater than, say, that required by the spray headers but sufficient to accommodate the large increase in volume undergone by a vaporising cryogen such as liquid nitrogen without any attendant rise in pressure much above atmospheric pressure.) The spray crystalliser shown in FIG. 6 may, if desired, be scaled up in one of two different ways. First, the size of the square figure along the sides of which the atomising nozzles are disposed may be increased, thereby allowing more nozzles to be accommodated. Second, there may be added further concentric and alternating arrays of atomising nozzles and cryogenic spray orifices.

Yet another embodiment of spray crystalliser is shown in FIG. 7. This embodiment is different from those shown in FIGS. 1 to 6 in that the housing 602 has a cylindrical shape, whereas in all the other embodiments the housing is box-shaped or cuboidal. Further, the atomising nozzles 604 are all circumferentially disposed and equally circumferentially spaced. In addition, rather than having rectilinear outlet apertures, as in the other illustrated embodiments, the nozzles 604 have elongate arcuate outlet apertures. As a result the atomised particles are ejected from each nozzle 504 as an arcuate sheet. The spacing of the nozzles 504 is typically that the sheets are contiguous or merge into one another to occupy most or all of the area of a cylindrical surface 620. A further consequence is that the spray headers 606 and 610 instead of being rectilinear tubes are in the form of rings similar to the one illustrated in FIG. 2 of EP-B-393 963. Of course, now, one spray ring 606 is positioned inside the cylindrical “sheet” 620 and the other spray ring 610 is positioned outside the sheet 620. In use of the inner spray ring 606 the cryogen is ejected generally radially outwards from a ring of orifices 608 and in use of the outer spray ring 610 the cryogen is ejected generally radially inwards from a ring of orifices 612. In other respects, however, the operation of the spray crystalliser shown in FIG. 7 is analogous to the operation of those described with reference to FIGS. 1 and 2 and FIGS. 3 to 6, respectively.

The spray crystalliser shown in FIG. 7 may, if desired, be scaled up in one of two different ways. First, the size of the circle on the circumference of which the atomising nozzles may be increased, thereby allowing more nozzles to be accommodated. Second there may be added further concentric rings of atomising nozzles and cryogenic spray orifices.

If desired, in any of the spray crystallisers shown in FIGS. 1 to 7, the position and/or orientation of the cryogen spray headers and their orifices relative to the atomising nozzle(s) may be adjustable and may be optimised for the particular product to be spray crystallised. In most cases in which a plurality of atomising nozzles is used the preferred arrangement is one in which the intersection of the cryogen with the oil (or other liquid to be spray crystallised) occurs upstream of (or above) any merger of oil sprays from separate atomising nozzles.

Referring now to FIG. 8, a chamber 702 is provided with an atomising nozzle 704 and liquid nitrogen spray headers 706 and 710 analogous to the comparable parts described with reference to and illustrated in FIGS. 1 and 2. The atomiser 704 is supplied with hot molten fat. The exact temperature of the molten fat is carefully controlled so as to ensure that delivery ducts and nozzles, including those of atomisers, are never at risk of blocking as a result of phase change (solidification). A pump 750 is employed to deliver the molten fat to the atomiser 704. The pump 704 is capable of delivering the molten fat at the required pressure for atomisation and at a chosen and accurately controlled mass flow rate. The pump 750 may for example be of the peristaltic kind. The spray headers 706 and 710 are supplied with liquid nitrogen via a common main 752 communicating via a pipeline 755 with a source 754 of pressurised liquid nitrogen (which source 754 may take the form of a conventional storage vessel).

The chamber 702 is open at its bottom terminating into a chute 756 which is able to guide free-flowing solidified particles of crystalline fat into the inlet of an auger 758 and through which gas comprising spent vaporised liquid nitrogen and atomising gas also flows into the inlet of the auger 758. Operation of the auger 758 urges the particles to a collection station 760 where they may be fed into suitable storage containers (not shown), for example into drums or sacks. The gas now largely but not completely free of entrained particles of solidified fat flows along a conduit 762 into a cyclone 764 in which residual entrained fine particles of solid fat are finally disengaged from the gas. The particles are discharged from the bottom of the cyclone 764, if desired, through a rotary valve 766 and may be collected in suitable storage containers. The gas may be vented from the top of the cyclone 764 to the atmosphere, or, if desired, may, as shown in FIG. 8, be compressed in a recycle compressor 768 to an atomising pressure and passed via a conduit 770 to the nozzle 704 as an atomising gas.

If such recycle is performed, another means is provided for venting gas from the apparatus shown in FIG. 8. For example, the chamber may be provided with an outlet 772 for gas at its top. The outlet 772 communicates via a pipeline 774 with a baghouse 776 operable in a conventional manner to remove particulate material from the gas. The gas may be vented via outlet pipe 778 to the atmosphere. If desired, a blower 780 may be provided to assist the flow through the baghouse 776. If desired a flow control valve 782 may be disposed in the pipeline 774 and associated via a programmable valve controller 784 of conventional kind with a pressure sensor 786 located in the chamber 702, the arrangement being such that the pressure may be maintained at a chosen pressure, typically in the range 1 to 1.5 bar, by automatic adjustment of the position of the valve 782.

If desired, the flow of liquid nitrogen (or other liquid cryogen) into the main 752 may be controlled by means of a flow control valve 790 in the pipeline 755. The valve 790 is operatively associated with a temperature sensor 792 (which may take the form of a thermocouple) able to sense the temperature of the spent gas. The temperature sensor 792 may be located in the chute 756 and generate temperature signals that are relayed to a programmable valve controller 794 of a conventional kind. In one arrangement, the flow control valve is operated to maintain the sensed temperature of the spent gas at a chosen value (say, minus 10° C.) or in a chosen range. The chosen value or range may be determined empirically to be that at or in which adequate solidification of the fat takes place with minimal or approaching minimal consumption of liquid nitrogen. One of the advantages of the method and apparatus is that they make it possible to keep down recirculation of solidified particles of fat within the chamber. Thus, the chosen temperature and nitrogen flow rates can be optimised to achieve set criteria, which may include desired product characteristics and/or minimum cryogen consumption per unit production of processed fat.

1. A method of cooling a feed liquid comprising forming at least one sheet of flowing particles of the feed liquid and directing cryogen at the particles from both sides of the sheet.

2. The method according to claim 1, wherein the sheet of flowing particles is formed by atomising the feed liquid.

3. The method according to claim 2, wherein the feed liquid is atomised by a compressed gas.

4. The method according to claim 1, wherein the said sheet is essentially planar.

5. The method according to claim 1, wherein the said sheet is curved.

6. The method according to claim 1, wherein the cryogen is a liquefied gas.

7. The method according to claim 6, wherein the liquefied gas is liquid nitrogen.

8. The method according to claim 1, wherein the feed liquid is atomised with a compressed gas which is formed of vapour evolved by the liquefied gas in cooling the particles.

9. The method according to claim 1, wherein the particles are solidified by contact with the cryogen.

10. The method according to claim 1, wherein the particles of the feed liquid have an average size less than 50 μm.

11. The method according to claim 10, wherein the particles are cooled by the cryogen at a rate of at least 1000 K/s.

12. The method according to claim 1, wherein the feed liquid is an edible substance.

13. The method according to claim 12, wherein the feed liquid is a molten fat or oil.

14. An Apparatus for cooling a feed liquid, comprising at least one nozzle for forming at least one sheet of flowing particles of the feed liquid, at least one first cryogen discharge member having a plurality of cryogen discharge orifices arranged for directing cryogen at one side of the sheet, and at least one second cryogen discharge member having a plurality of cryogen discharge orifices arranged for directing cryogen at the other side of the sheet.

15. The apparatus according to claim 14, in which the nozzle points vertically downwards.

16. The apparatus according to claim 15, wherein the nozzle has an inlet for atomising gas.

17. The apparatus according to claim 14, wherein the nozzle has a rectilinear elongate outlet.

18. The apparatus according to claim 14, wherein there is a plurality of nozzles arranged in one or more straight lines.

19. The apparatus according to claim 18, wherein at least some of the straight lines are parallel to one another.

20. The apparatus according to claim 18, wherein at least some of the straight lines essentially define a geometric figure selected from a triangle, a square, a rectangle, and a polygon.

21. The apparatus according to claim 14, wherein the said nozzle has a curved elongate outlet.

22. The apparatus according to claim 15, wherein a plurality of nozzles are arranged circumferentially.

23. The apparatus according to claim 18, wherein the orifices of the first and second cryogen discharge members are disposed in geometric configurations complementary to that or those of the nozzles.

24. The apparatus according to claim 14, wherein the orifices of the first and second discharge members are disposed such that in use they are all equidistant from the said sheet of particles.

25. The apparatus according to claim 18, wherein the nozzles are disposed in the upper region of a single generally cuboidal chamber.

26. The apparatus according to claim 18, wherein the nozzles are disposed in the upper regions of a plurality of contiguous generally cuboidal chambers.

27. The apparatus according to claim 26, wherein the chambers are open to one another through their common sides.

28. The apparatus according to claim 14, wherein the first and second cryogen discharge members are both spray headers.

29. The apparatus according to claim 14, wherein the said orifices are orientated so as, in use, to direct cryogen at the said sheet near to its source.

30. The apparatus according to claim 14, in which the or each nozzle and the cryogen discharge members are housed in a chamber having an outlet for the cooled particles and the same or a different.

31. The apparatus according to claim 30, additionally including a sensor for sensing the temperature of the spent cryogen, the sensor being operatively associated with at least one flow control valve for controlling the flow of cryogen to the cryogen discharge members.

32. The apparatus according to claim 30, additionally including a cyclone for disengaging fine particles from the spent cryogen.

33. The apparatus according to claim 32, additionally including a compressor having an inlet communicating with the cyclone and an outlet communicating with a pipeline for feeding atomising gas to the atomising nozzle.

34. The apparatus according to claim 33, wherein the chamber has a further outlet for spent cryogen, the further outlet communicating with a baghouse for disengaging fine particles from the spent cryogen.
